(19) United States
(12) Patent Application Publication
(10) Pub. No.: US 2011/0070417 A1
(43) Pub. Date: Mar. 24, 2011

(54) SUBSTRATE PROVIDED WITH A STACK HAVING THERMAL PROPERTIES

(75) Inventors: Pascal Reutler, Paris (FR); Hadia Gerardin, Paris (FR)

(73) Assignee: Saint-Gobain Glass France, Courbevoie (FR)

(21) Appl. No.: 12/933,240

(22) PCT Filed: Mar. 17, 2009
(86) PCT No.: PCT/FR09/50444

§ 371 Date: Nov. 16, 2010

(30) Foreign Application Priority Data
Mar. 18, 2008 (FR) 0851731

(51) Int. Cl. B32B 7/02; B05D 5/06; B32B 37/00

(52) U.S. Cl. 428/213; 427/160; 156/278

(57) ABSTRACT

The invention relates to a glass substrate (10) provided on a main face with a stack of thin layers comprising a metallic functional layer (40) with reflective properties in the infrared and/or in solar radiation, based notably on silver or a metal alloy containing silver, and two antireflective coatings (20, 60), each of said coatings having at least one dielectric layer (22, 64) based on silicon nitride, optionally doped with at least one other element, such as aluminum, said functional layer (40) being disposed between the two antireflective coatings (20, 60), characterized in that the optical thickness e₆₀ in nm of the overlying antireflective coating (60) is: e₆₀=5×e₄₀+α, where e₄₀ is the geometric thickness in nm of the functional layer (40) such that 13≦e₄₀≦25, and preferably 14≦e₄₀≦18, and where α is a number=25±15.

The invention relates to a transparent substrate, notably made of a rigid inorganic material such as glass, said substrate being covered with a stack of thin layers including a functional layer of the metallic type that can act on solar radiation and/or long wavelength infrared radiation.

The invention relates more particularly to the use of such substrates for producing glazing for thermal insulation and/or solar protection. These types of glazing may be intended both for equipping buildings as well as vehicles, with a view in particular of reducing the stress of air conditioning and/or to prevent excessive overheating (glazing called “solar control glazing”) and/or to reduce the quantity of energy dissipated to the outside (glazing called “low emission glazing”) brought about by the ever increasing size of glazed surfaces in buildings and passenger compartments of vehicles.

These types of glazing may moreover be incorporated in glazing having particular functions, such as for example heating glazing or electrochromic glazing.

A type of stack known to confer such properties on substrates consists of a metallic functional layer with reflective properties in the infrared and/or in solar radiation, notably a metallic functional layer based on silver or a metal alloy containing silver.

In this type of stack, the functional layer is thus positioned between two antireflective coatings, each generally having several layers, each of which is made up of a dielectric material of the nitride type and notably silicon or aluminum nitride or oxide. From the optical point of view, the object of these coatings that the metallic functional layer includes is to make this metallic functional layer “antireflective”.

A blocking coating is however sometimes inserted between one or each antireflective coating and the metallic functional layer, the blocking coating positioned under the functional layer in the direction of the substrate encouraging the crystalline growth of this layer and protecting it during any high-temperature thermal treatment, of the bending and/or tempering type, and the blocking coating positioned over the functional layer opposite the substrate protects this layer from any deterioration when the upper antireflective coating is deposited and during any high-temperature heat treatments, of the bending or tempering type.

At the present time, stacks of low-emission thin layers exist with a single functional layer (referred to hereinafter by the expression “functional monolayer stack”), based on silver, having a normal emissivity ∈_{N} of the order of 3%, a light transmission in the visible T_{L} of the order of 80% and a selectivity of the order of 1.3 when they are mounted in conventional double glazing, as for example in face 3 of a configuration: 4-16(Ar-90%)-4, consisting of two 4 mm glass sheets separated by a gas layer with 90% argon and 10% air having a thickness of 16 mm, of which one of the sheets is coated with a functional monolayer stack: the sheet most inside the building when considering the incident direction of solar light entering the building; on its face turned towards the gas layer.

As a reminder, selectivity corresponds to the ratio of the light transmission T_{Lvis} in the visible region of the glazing to the solar factor SF of the glazing and is such that: S=T_{Lvis}/SF.

The solar factor of the glazing is the ratio of total energy entering into the premises through this glazing to the total incident solar energy.

A person skilled in the art would know that to position the stack of thin layers in face 2 of double glazing (on the sheet most inside the building when considering the incident direction of solar light entering the building and on its face turned towards the gas layer) will enable it to reduce the solar factor and thus to increase selectivity.

Within the context of the above example, it is then possible to obtain selectivity of the order of 1.35.

In order to reduce emissivity, a person skilled in the art will also know that the thickness of the silver layer may be increased. This makes it possible to increase the selectivity to a value of 1.5 when the stack is positioned in face 2 of the double glazing, but this results in a reduction in light transmission in the visible and especially an increase in light reflection in the visible to values that are difficult to accept, that are of the order of 35% to 45%. Moreover, this may result in an unacceptable coloration, notably in reflection, in particular in the red.

The most efficient solution consists then of employing a stack with several functional layers, positioned in face 2 of the glazing and notably a stack with two functional layers (referred to hereinafter by the expression “functional bilayer stack”), in order to retain their high light transmission in the visible, while maintaining low light reflection in the visible. It thus possible to obtain, for example, a selectivity >1.4, even >1.5 and even >1.6 and a light reflection of the order of 15%, or even of the order of 10%.

This solution may moreover make it possible to obtain an acceptable coloration, notably in reflection, in particular that is not in the red.

However, on account of the complexity of the stack and the quantity of material deposited, these stacks with several functional layers are more costly to produce than functional monolayer stacks.

The object of the invention is to be able to remedy the disadvantages of the prior art, by developing a novel type of functional monolayer stack, a stack that has a low sheet resistance (and therefore low emissivity), high light transmission and a relatively neutral color, in particular in reflection on the layers side (but also on the opposite side: “substrate side”), and where these properties are preferably preserved within a restricted range, whether or not the stack undergoes one (or more) high-temperature heat treatments of the bending and/or tempering and/or annealing type.

Another important object is to provide a functional monolayer stack that has low emissivity while having low light reflection in the visible, as well as an acceptable coloration, notably in reflection, in particular that is not in the red.

The object of the invention is therefore, as more widely accepted, a glass substrate as claimed in claim 1. This substrate is provided on a main face with a stack of thin layers comprising a metallic functional layer with reflective properties in the infrared and/or in solar radiation, based notably on silver or a metal alloy containing silver, and two antireflective coatings, each of said coatings having at least one dielectric layer based on silicon nitride, optionally doped with at least one other element, such as aluminum, said functional layer being disposed between the two antireflective layers, on the one hand the functional layer being optionally deposited on a under-blocking coating disposed between the underlying antireflective coating and the functional layer and, on the other hand, the functional layer being optionally deposited directly under an over-blocking coating disposed between the functional layer and the overlying antireflective coating, characterized in that the optical thickness e₆₀ in nm of the overlying antireflective coating is: e₆₀=5×e₄₀+α, where e₄₀ is the geometric thickness in nm of the functional layer such that 13≦e₄₀≦25, and preferably 14≦e₄₀≦18, and where α is a number=25±15.

α is preferably a number=25±10, or even α is a number=25±5, which represents a variable of the definition of optical thickness, in nm.

“Optical thickness e₆₀ in nm of the overlying antireflective coating” is understood to mean, within the context of the invention, the total optical thickness of the dielectric layer or of all the dielectric layers of this coating that is or are disposed above the metallic functional layer, opposite the substrate, or above the over-blocking coating if it is present.

Similarly “optical thickness e₂₀ in nm of the underlying antireflective coating” is understood to mean, within the context of the invention, the total optical thickness of the dielectric layer or of all the dielectric layers of this coating that is or are disposed between the substrate and the metallic functional layer or between the substrate and the under-blocking coating if it is present.

The dielectric layer based on silicon nitride, optionally doped with at least one other element, such as aluminum, which is at a minimum included in each antireflective coating, as previously defined, has an optical index measured at 550 nm between 1.8 and 2.5 including these values, or preferably between 1.9 and 2.3, or even between 1.9 et 2.1 including these values.

As usual, the refractive indices, and consequently the optical thicknesses obtained from the refractive indices, are considered here at a wavelength of 550 nm.

The stack according to the invention is a low-emissive stack so that the sheet resistance R in ohms per square of the functional layer is preferably such that: R×e₄₀²−A<25×e₄₀, with A a number=580, or even=500, or even =450, or even=420, or even=200, or even=120. From this formula, it is defined that the metallic functional layer is better crystallized the smaller is A and this layer then has an absorption that is lower in the infrared and a reflection in the infrared that is higher.

Moreover, in order to obtain an acceptable compromise between high light transmission of neutral colors in reflection and a relatively high selectivity, the ratio E of the optical thickness e₂₀ in nm of the underlying antireflective coating to the optical thickness e₆₀ in nm of the overlying antireflective coating is preferably such that: 0.3≦E≦0.7, or even 0.4≦E≦0.6.

In a particular variant, said dielectric layers based on silicon nitride, optionally doped with at least one other element, such as aluminum, have respectively for the dielectric layer based on silicon nitride of the underlying dielectric coating, a physical thickness of between 5 and 25 nm, or even between 10 and 20 nm and for the dielectric layer based on silicon nitride of the overlying antireflective coating a physical thickness of between 15 and 60 nm, or even between 25 and 55 nm.

In a particular variant, the final layer of the underlying antireflective coating, the furthest away from the substrate, is a wetting layer based on oxide, notably based on zinc oxide, optionally doped with at least one other element, such as aluminum.

In a particular variant, the underlying antireflective coating comprises at least one dielectric layer based on nitride, notably silicon nitride and/or aluminum nitride and at least one non-crystallized smoothing layer made of a mixed oxide, said smoothing layer being in contact with a crystallized overlying wetting layer.

Preferably, the under-blocking coating and/or over-blocking coating comprises a thin layer based on nickel or titanium having a geometric thickness e such that 0.2 nm≦e≦1.8 nm.

In a particular version, at least one thin nickel-based layer, and notably that of the over-blocking coating, includes chromium, preferably in quantities by weight of 80% Ni and 20% Cr.

In another particular version, at least one thin nickel-based layer, and notably that of the over-blocking coating, includes titanium, preferably in quantities by weight of 50% Ni and 50% Ti.

In addition, the under-blocking coating and/or the over-blocking coating may include at least one thin nickel-based layer present in metallic form if the substrate provided with a stack of thin layers has not undergone a bending and/or tempering heat treatment after the stack is deposited, this layer being at least partially oxidized if the substrate provided with a stack of thin layers has undergone at least one bending and/or tempering heat treatment after deposition of the stack.

The thin nickel-based layer of the under-blocking coating and/or the thin nickel-based layer of the over-blocking coating when it is present is preferably directly in contact with the functional layer.

The final layer of the underlying antireflective coating, that which is furthest away from the substrate is preferably based on oxide, preferably deposited sub-stoichiometrically, and is notably based on titanium (TiOₓ) or based on a mixed oxide of zinc and tin (SnZnOₓ), and optionally with another element at a rate of a maximum of 10% by mass.

The stack may thus have a final layer or overcoat, namely a protective layer, preferably deposited sub-stoichiometrically. This layer becomes oxidized, essentially stoichiometrically, in the stack after deposition.

This protective layer, preferably has a thickness of between 0.5 and 10 nm.

The glazing according to the invention incorporates at least the substrate carrying the stack according to the invention, optionally associated with at least one other substrate. Each substrate may be clear or colored. At least one of the substrates may be a body colored glass. The choice of the type of coloration will be depend on the degree of light transmission and/or the colorimetric appearance desired for the glazing once its manufacturer is complete.

The glazing according to the invention may have a laminated structure, associating notably at least two rigid substrates of the glass type with at least one sheet of thermoplastic polymer, in order to have a structure of the glass/stack of thin layers/glass sheet(s) type. The polymer may notably be based on polyvinylbutyral PVB, ethylene vinylacetate EVA, polyethylene terephthalate PET, or polyvinylchloride PVC.

Glazing may also have a structure of the glass/stack of thin layers/polymer sheet(s) type.

The type of glazing according to the invention is able to undergo heat treatment without damage to the stack of thin layers. They are thus optionally bent and/or tempered.

The glazing may be bent and/or tempered while consisting of a single substrate, this provided with the stack. It then consists of glazing called <<monolithic>>. In the case where they are bent, notably with a view to producing glazing for vehicles, the stack of thin layers is preferably situated on a face that is at least partially non-planar.

The glazing may also be multiple glazing, notably double glazing, at least the substrate carrying the stack being able to be bent and/or tempered. It is preferable in a multiple glazing configuration for the stack to be positioned so as to be turned in the direction of the interposed gas layer. In a laminated structure, the substrate carrying the stack may be in contact with the polymer sheet.

The glazing may also be triple glazing consisting of three sheets of glass separated in two-by-two by a gas layer. In a structure made of triple glazing, the substrate carrying the stack may be in face 2 and/or in face 5, when it is considered that the incident direction of the solar light passes through the faces in the increasing order of their number.

When the glazing is monolithic or multiple of the double glazing, triple glazing or laminated glazing type, at least the substrate carrying the stack may be made of bent or tempered glass, this substrate being able to be bent or tempered before or after deposition of the stack.

When this glazing is mounted in a double glazing, it preferably has a selectivity S≧1.4 or even S is >1.4 or S≧ 1.5 or even S>1.5.

The invention also relates to a process for manufacturing substrates according to the invention, which consist of depositing the stack of thin layers on its substrate by a technique under vacuum of the cathode sputtering type optionally assisted by a magnetic field.

It is however not excluded that the first layer or layers of the stack may be deposited by another technique, for example by a thermal decomposition technique of the pyrolysis type.

The invention also relates to a process for manufacturing a stack according to the invention wherein the underlying antireflective layer is deposited in an optical thickness e₆₀, in nm: e₆₀=5×e₄₀+α, where e₄₀ is the geometric thickness in nm of the functional layer and where α is a number=25±15.

The invention moreover relates to the use of the substrate according to the invention, for producing a double glazing that has a selectivity S≧1.4, or even S>1.4 or S≧ 1.5, or even S>1.5.

The substrate according to the invention may in particular be used for producing a transparent electrode of heating glazing or of electrochromic glazing or a lighting device or a display device or a photovoltaic cell.

Advantageously, the present invention thus makes it possible to produce a stack of thin layers with a functional monolayer having a multiple glazing configuration, and notably a double glazing configuration, a high selectivity (S≧1.40), a low emissivity (∈_{N}≦3%) and favorable aesthetics (T_{Lvis}≧60%, R_{Lvis}≧30%, neutral colors in reflection), whereas up to now only bilayer stacks enabled this combination of criteria to be obtained.

The functional monolayer stack according to the invention is less costly to produce than a stack with a functional bilayer stack having similar characteristics.

It is even possible, within the scope of the invention, to produce a functional monolayer stack that has lower emissivity than a functional bilayer stack that would however have a total thickness of the functional layer greater than that of this functional monolayer stack.

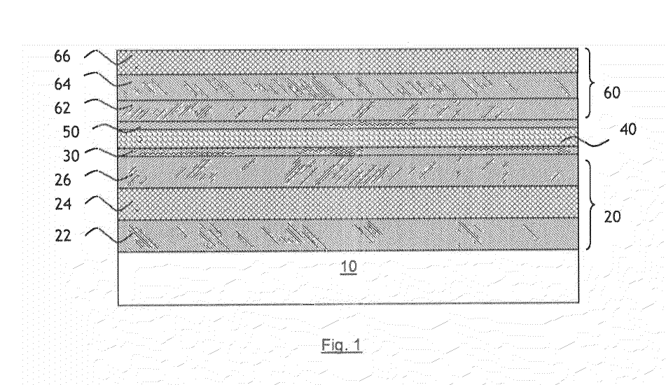

Details and advantageous characteristics of the invention will emerge from the following non-limiting examples, illustrated with the appended FIG. 1 illustrating a functional monolayer stack according to the invention, the functional layer being provided with an under-blocking coating and an over-blocking coating and the stack being moreover provided with an optional protective coating.

In this figure, the proportions between the thicknesses of the various layers are not rigorously followed in order to make it easier to read them.

In addition, in all the following examples, the stack of thin layers is deposited on a substrate 10 made of soda lime glass with a thickness of 4 mm.

Moreover, for these examples, in all cases where a heat treatment has been applied to the substrate, annealing took place during approximately 8 minutes at a temperature of approximately 620° C. followed by cooling in ambient air (approximately 20° C.) in order to simulate a bending or tempering heat treatment.

Thus, for each of the examples, when a characteristic was measured before this heat treatment, it is classified in the column: BHT and when it was measured after this heat treatment it is classified in the column: AHT.

For all the following examples, for a double glazing assembly, the stack of thin layers was deposited in face 3, that is to say on the sheet that is most outside the building when the incident direction of solar light is considered entering the building; on the face turning towards the gas layer.

FIG. 1 illustrates a stack structure with a functional monolayer deposited on a transparent glass substrate 10, in which the single functional layer 40 is positioned between two antireflective coatings, the underlying antireflective coating 20 situated below the functional layer 40 in the direction of the substrate 10 and the overlying antireflective coating 60 positioned above the functional layer 40 opposite the substrate 10.

Each of these two antireflective coatings 20, 60 has at least one dielectric layer 22,24,26; 62,64,66.

Optionally, on one hand, the functional layer 40 may be deposited over a under-blocking coating 30 positioned between the underlying antireflective coating 20 and the functional layer 40 and, on the other hand, the functional layer 40 may be positioned directly under an over-blocking coating 50 positioned between the functional layer 40 and the underlying antireflective coating 60.

In FIG. 1, it will be noted that the lower antireflective coating 20 has three antireflective layers 22,24 and 26, that the upper antireflective coating has two antireflective coatings 62,64, and that this antireflective coating 60 is terminated by an optional protective layer 66, in particular based on oxide, notably sub-stoichiometric in oxygen.

According to the invention, the optical thickness e₆₀ in nm of the underlying antireflective coating 60 is:

e₆₀=5×e₄₀+α, (equation (1))

where e₄₀ is the geometric thickness in nm of the functional layer 40 such that 13≦e₄₀≦25, and preferably 14≦e₄₀−18, and where α is a number (not necessarily an integer) representing a thickness in nm and lying between 25+15 and 25 −15, that is between 40 et 10.

In addition, and preferably, the sheet resistance R in ohms per square of the functional layer 40 in nm (measured without a heat treatment of the bending and tempering type of the substrate coated with the stack) is such that:

R×e₄₀²−A<25×e₄₀ (equation (2))

with A a number (not necessarily an integer)=580, or even=500, or even=450, or even=420, or even=250, or even=120.

In point of fact, the sheet resistance of a thin conductive film depends on its thickness according to the Fuchs-Sondheimer law which is expressed by:

R_{c}×t²=ρ×t+Y.

In this formula, Rc denotes the sheet resistance, t denotes the thickness of the thin film in nm, ρ denotes the intrinsic resistivity of the material forming the thin layer and Y corresponds to the specular or diffuse reflection of charge carriers in the region of the interfaces. The invention makes it possible to obtain an intrinsic resistivity ρ such that ρ is of the order of 25 Ω·nm and an improvement of the reflection of the carriers such that Y is equal to or less than 600 (nm)² Ohms.

Very low values of Y may be obtained for example by employing the technology disclosed in the international patent application published under number WO 2005/070540.

Moreover, preferably, the ratio E of the optical thickness e₂₀ in nm of the underlying antireflective coating 20 to the optical thickness e₆₀ in nm of the overlying antireflective coating 60 is such that:

0.3≦E≦0.7, or even 0.4≦E≦0.6 (equation (3)).

A numeral simulation was first of all performed (examples 1, 2 and 3 below), and a stack of thin layers was actually deposited: example 4.

Table 1 below shows the thickness in nanometers of each of the layers or coatings of examples 1 to 3 and the main characteristics of these examples:

TABLE 1

| Layer | Ex. 1 | Ex. 2 | Ex. 3 |
|---|---|---|---|
| Optical thickness e₂₀ | 60 | 60 | 60 |
| Geometric thickness e₄₀ | 12 | 16 | 16 |
| Optical thickness e₆₀ | 88 | 88 | 105 |
| α | 28 | 8 | 25 |
| T_{Lvis} (%) | 80.6 | 77.4 | 73.9 |
| SF (%) | 57.3 | 50.1 | 49.6 |
| S | 1.39 | 1.53 | 1.48 |
| a_{Rg}* | −0.2 | 9.0 | 0.6 |
| b_{Rg}* | −7.0 | 0.3 | −3.4 |

In this table, the optical properties given consist of:
T_{Lvis} the light transmission T_{L} in the visible in %, measured with the illuminant D65,
the solar factor SF
the selectivity S corresponding to the ratio of the light transmission
T_{Lvis} in the visible to the solar factor SF such that S=T_{Lvis}/SF, and
colors in reflection a_{Rg}* and b_{Rg}* in the LAB system measured with the illuminant D65, on the side of the substrate opposite the main face on which the stack of thin layers is deposited,

the light transmission T_{Lvis}, the solar factor SF and the selectivity S being considered in the double glazing configuration 4-16 (Ar 90%)-4.

For example 1, a silver monolayer stack was modeled so that the optical thickness e₆₀ in nm of the overlying antireflective coating 60 verifies equation (1) with α=28. The selectivity is low for this silver thickness: S=1.39.

By increasing the silver thickness of the stack to 16 nm, without changing the thickness of the dielectrics, in order to obtain example 2, the value of α found is outside equation (1): α=8. Although the selectivity is very good on account of a reduction in the solar factor, the product is not acceptable in that it exhibits a red color in reflection, as the high value of a_{Rg}* shows.

By adapting the thickness of the overlying antireflective coating 60 so as to verify equation (1) with α=25, so as to obtain example 3, a suitable aesthetic is found and the selectivity remains good: S=1.48.

Example 4 was carried out on the basis of the functional monolayer stack structure illustrated in FIG. 1 in which the functional layer 40 is provided with a under-blocking coating 30 and with an over-blocking coating 50 respectively immediately under and immediately over the functional layer 40.

However, within the context of example 4, there was no under-blocking coating 30.

In addition, in the stack structure, a lower antireflective coating 20 is deposited immediately under the under-blocking coating 30 and in contact with the substrate 10 and an upper antireflective coating 60 is deposited immediately on the over-blocking coating 50.

Table 2 below shows the geometrical thickness (and not the optical thickness) in nanometers of each of the layers of example 4:

TABLE 2

| Layer | Material | Ex. 4 |
|---|---|---|
| 66 | SnZnOₓ:Sb | 4 |
| 64 | Si₃N₄:Al | 28 |
| 62 | ZnO:Al | 20 |
| 50 | NiCr | 1 |
| 40 | Ag | 15.6 |
| 26 | ZnO:Al | 4 |
| 24 | SnZnOₓ:Sb | 5 |
| 22 | Si₃N₄:Al | 19 |

According to the teaching of international patent application N° WO 2007/101964, the underlying antireflective coating 20 comprises a dielectric layer 22 based on silicon nitride and at least one non-crystalline smoothing layer 24 made of a mixed oxide, in the event a mixed oxide of zinc and tin that is here doped with antimony (deposited from a metal target consisting of 65:34:1 mass ratio respectively for Zn:Sn:Sb), said smoothing layer 24 being in contact with said overlying wetting layer 26.

In this stack, the wetting layer 26 made of zinc oxide doped with aluminum ZnO:Al (deposited from a metal target consisting of zinc doped to the extent of 2% by weight of aluminum) makes it possible to improve the crystallization of silver, which improves its conductivity. This effect is accentuated by the use of the amorphous smoothing layer of SnZnOₓ:Sb, which improves the growth of ZnO and therefore of silver.

The layers of silicon nitride 22,64 are made of Si₃N₄ doped to the extent of 10% by weight with aluminum.

This stack has moreover the advantage that it can be tempered.

The thickness of the overlying antireflective coating 60 verifies equation (1). In theory, according to this equation, the optical thickness e₆₀ nm should be 103 for a value α=25. In practice, an optical thickness e₆₀ in nm of 105 has been measured, which gives the value α=27.

The optical thickness e₂₀ in nm of the underlying antireflective coating 20 is: e₂₀=63.

The ratio E of the optical thicknesses E=e₂₀/e₆₀ is 0.6 and it therefore verifies equation (3).

The properties of resistivity, optical properties and energy properties of this example are given in table 3 below:

In this table, the optical properties given consist of:
T_{Lvis} light transmission T_{L} in the visible in %, measured with the illuminant D65, which is 50% and even 60%,
R_{Lvis}, light reflection R_{L} in the visible in %, measured on the outer side of the double glazing, with the illuminant D65, which is ≧35% and even ≦30%,
Colors in reflection a_{Rg}* and b_{Rg}* in the LAB system measured with the illuminant D65, on the side of the substrate opposite the main face on which the stack of thin layers is deposited, which are neutral, slightly in the blue,
Solar factor SF that is ≧50% and even 5 45%,
Selectivity S=T_{Lvis}/SF and which is ≧1.4, and even ≧1.5,

the light transmission T_{Lvis}, the light reflection R_{Lvis}, the solar factor SF and the selectivity S being considered in a double-glazing configuration 4-16 (Ar 90%)-4.

TABLE 3

| | R | T_{Lvis} | | | | SF | |
|---|---|---|---|---|---|---|---|
| Ex. | (ohms/□) | (%) | R_{Lvis}(%) | a_{Rg}* | b_{Rg}* | (%) | S |
| 4 BHT | 2.4 | 64.5 | 26.4 | −0.2 | −11.1 | 43.4 | 1.5 |
| 4 AHT | 1.9 | 66.7 | 25.7 | 1.9 | −6.5 | 44.4 | 1.5 |

Thus, the sheet resistance of the stack, before as well as after the heat treatment of example 4 according to the invention is still less than 3 ohms per square and results in normal emissivity ∈_{N} within the range 1 to 2.5% before heat treatment and within the range 1 to 2% after heat treatment.

In addition, 25×e₄₀=390, and R×e₄₀²−580=4.064; which is well below 390.

The sheet resistance R of the functional layer 40 before heat treatment therefore indeed verifies: R×e₄₀²−A<25×e₄₀ (equation (2)) with A=580 or A=500 or A=400 and even with A=200.

This equation (2) is moreover verified with the sheet resistance measured after heat treatment.

This example shows that it is possible to combine high selectivity and low emissivity, with a stack having a single functional metal layer made of silver, while preserving suitable aesthetics (T_{Lvis} is greater than 60%, R_{Lvis} is less than 30% and the colors are neutral in reflection).

Moreover the light reflection R_{Lvis}, the light transmission T_{Lvis} measured with the illuminant D65 and the colors in reflection a* and b* in the LAB system measured with the illuminant D65 on the substrate side do not vary in a truly significant manner during heat treatment.

By comparing the optical and energy characteristics before heat treatment with these same characteristics after heat treatment, no major deterioration was observed.

The stack of example 4 is thus a stack that can be tempered within the meaning of the invention since the variation in light transmission in the visible is less than 5 and even less than 3.

It is thus difficult to distinguish substrates according to example 4 having undergone heat treatment from substrates respectively of the same example that have not undergone heat treatment, when they are placed side by side.

Moreover, the mechanical strength of the stack according to the invention is very good by the virtue of the presence of the protective layer 66.

In addition, the general chemical resistance of this stack of example 4 is good overall.

On account of the high thickness of the silver layer (and therefore of the low sheet resistance obtained) as well as good optical properties (in particular light transmission in the visible), it is possible moreover to use the substrate coated with the stack according to the invention to produce a transparent electrode substrate.

This transparent electrode substrate may be suitable for an organic electroluminescent deposit, in particular by replacing the layer 64 made of silicon nitride of example 4 by a conductive layer (with, in particular a resistivity less than 10⁵ Ω·cm) and notably a layer based on oxide. This layer may for example be made of tin oxide or with a zinc oxide base optionally doped with Al or Ga, or with a mixed oxide base, and notably of indium and tin oxide ITO, indium oxide and zinc oxide IZO, or tin oxide and zinc oxide SnZn optionally doped (for example with Sb, F). This organic electroluminescent device may be used for producing a lighting device or a display device (screen).

In a general manner, the transparent electrode substrate may be suitable for heating glazing, for any electrochromic glazing, any display screen or for a photovoltaic cell and notably for a rear face of a transparent photovoltaic cell.

The present invention is described in the preceding account as an example. It is understood that a person skilled in the art will be able to produce several variants of the invention without for all that departing from the scope of the invention as defined in the claims.

1. A transparent substrate provided on a main face with a stack of thin layers comprising a metallic functional layer with reflective properties for infrared and/or in solar radiation, and an underlying and an overlying antireflective coating,
said antireflective coatings having at least one dielectric layer comprising silicon nitride, optionally doped with at least one other element,
said functional layer being disposed between the underlying and overlying antireflective coatings
on the one hand the functional layer being optionally deposited on an under-blocking coating disposed between the underlying antireflective coating and the functional layer and,
on the other hand, the functional layer being optionally deposited directly under an over-blocking coating disposed between the functional layer and the overlying antireflective coating,
wherein a sheet resistance R in ohms per square of the functional layer is such that: R×e₄₀²−A<25×e₄₀, with A being 580; and
an optical thickness e₆₀ in nm of the overlying antireflective coating is: e₆₀=5×e₄₀+α, where e₄₀ is the geometric thickness in nm of the functional layer such that 13≦e₄₀≦25, and where α is 25±15.

2. The substrate of claim 1, wherein α is a number=25±10.

3. (canceled)

4. The substrate of claim 1, wherein a ratio E of an optical thickness e₂₀ in nm of the underlying antireflective coating to the optical thickness e₆₀ in nm of the overlying antireflective coating is such that: 0.3≦E≦0.7.

5. The substrate of claim 1, wherein the at least one dielectric layer is a first and a second dielectric layer, each comprising silicon nitride, optionally doped with at least one other element having, respectively,
for the first dielectric layer comprising silicon nitride of the underlying dielectric coating, a physical thickness of between 5 and 25 nm, and
for the second dielectric layer comprising silicon nitride of the overlying antireflective coating a physical thickness of between 15 and 60 nm.

6. The substrate of claim 1, wherein a final layer of the underlying antireflective coating, furthest away from the substrate, is a wetting layer comprising an oxide, optionally doped with at least one other element.

7. The substrate of claim 6, wherein the underlying antireflective coating comprises at least one dielectric layer comprising a nitride and at least one non-crystallized smoothing layer comprising a mixed oxide, said smoothing layer being in contact with a crystallized overlying wetting layer.

8. The substrate of claim 1, wherein the under-blocking coating and/or the over-blocking coating comprises a thin layer comprising nickel or titanium having a geometric thickness e such that 0.4 nm≦e≦1.8 nm.

9. The substrate of claim 8, wherein at least one thin nickel-comprising layer, comprising chromium, optionally in a quantity by weight of 80% Ni and 20% Cr.

10. The substrate of claim 8, wherein at least one thin nickel-comprising layer comprises titanium optionally in a quantity by weight of 50% Ni and 50% Ti.

11. The substrate of claim 1, wherein the under-blocking coating and/or the over-blocking coating comprise at least one thin nickel-comprising layer present in metallic form if the substrate, provided with a stack of thin layers, has not undergone a bending and/or tempering heat treatment after the stack is deposited, said alloy being at least partially oxidized if the substrate provided with the stack of thin layers has undergone at least one bending and/or tempering heat treatment after deposition of the stack.

12. The substrate of claim 8, wherein the thin nickel-based layer of the under-blocking coating and/or the over-blocking coating is directly in contact with the functional layer.

13. The substrate of claim 1, wherein a the final layer of the overlying antireflective coating, which is furthest away from the substrate, comprises an oxide.

14. A glazing incorporating at least one substrate as claimed in claim 1, optionally associated with at least one other substrate, said glazing being mounted as a monolith or in a multiple glazing of the double glazing or triple glazing, laminated glazing, and the substrate upon which the layers are is optionally bent and/or tempered.

15. The glazing of claim 13, having mounted as a double glazing, a selectivity S≧1.4.

16. A process for manufacturing a glass substrate provided on a main face with a stack of thin layers, the stack comprising a metallic functional layer with reflective properties in the infrared and/or in solar radiation, and an underlying and an overlying antireflective coating, each of said coatings having at least one dielectric layer comprising silicon nitride, optionally doped with at least one other element, said functional layer being disposed between the underlying and overlying antireflective coatings, on the one hand the functional layer being optionally deposited on a under-blocking coating disposed between the underlying antireflective coating and the functional layer and, on the other hand, the functional layer being optionally deposited directly under an over-blocking coating disposed between the functional layer and the overlying antireflective coating, wherein a sheet resistance R in ohms per square of the functional layer is such that: R×e₄₀²−A<25×e₄₀ with A being 580; and
underlying reflective coating is deposited in an optical thickness e₆₀ in nm e₆₀=5×e₄₀+α, wherein e₄₀ is the geometric thickness in nm of the functional layer and where α is 25±15.

17. A process for producing a double glazing that has a selectivity S≧1.4 or a transparent electrode of a heating or electrochromic glazing, or a lighting or display device, or a photovoltaic cell comprising affixing the substrate of claim 1 to a surface.

18. The transparent substrate of claim 1, wherein the metallic functional layer comprises silver or a metal alloy comprising silver.

19. The process of claim 16, wherein the metallic functional layer comprises silver or a metal alloy comprising silver.

20. The transparent substrate of claim 1, wherein A is 500.

21. The transparent substrate of claim 1, wherein A is 450.
